(19) United States
(12) Patent Application Publication
(10) Pub. No.: US 2023/0267370 A1
(43) Pub. Date: Aug. 24, 2023

(54) MACHINE LEARNING-BASED CONVERSATION ANALYSIS

(71) Applicant: Accenture Global Solutions Limited, Dublin (IE)

(72) Inventors: Shannon Copeland, Atlanta, GA (US); Burton M. Smith, III, Panama City Beach, FL (US)

(21) Appl. No.: 18/111,038

(22) Filed: Feb. 17, 2023

Related U.S. Application Data
(60) Provisional application No. 63/313,512, filed on Feb. 24, 2022.

(51) Int. Cl. G06N 20/00

(52) U.S. Cl. CPC G06N 20/00

(57) ABSTRACT

Methods, systems, and apparatus, including computer programs encoded on a computer storage medium, for enhancing user interaction with an interface, including obtaining multiple communications, each communication in the multiple communications representing one of: a phone conversation transcript, an email, or a chat transcript between a business development representative and a potential customer, extracting, from the multiple communications, one or more features for each communication in the multiple communications based on a pre-generated taxonomy, generating a training dataset that includes multiple training samples, each training sample mapping at least one extracted feature of a particular communication to a metric indicative of progress of a sales process, and training a machine learning model using the training dataset to generate a trained model that accepts as input, features extracted from a run-time communication associated with the sales process, and outputs a suggested follow-up communication likely to improve progress of the sales process.

### PRIORITY CLAIM

This application claims priority to U.S. Provisional Application 63/313,512, filed on Feb. 24, 2022, the entire content of which is incorporated herein by reference.

### TECHNICAL FIELD

This specification relates to machine learning solutions for conversation analysis.

### BACKGROUND

A sale process can involve identifying sales leads through marketing campaigns for products and/or services by one business to other businesses. These leads are then each assigned to a business development representatives (BDR) who pursues the opportunity by communicating with one or more leads, and in the process provides the potential customer, information regarding the products and/or services and answering all queries originating from the potential customer. Each sale process (or cycle) can include multiple communications between a BDR and a potential customer.

### SUMMARY

In general, one innovative aspect of the subject matter described in this specification can be embodied in methods including the operations of obtaining multiple communications, each communication in the multiple communications representing one of: a phone/audio conversation transcript, an email, a video conversation transcript, or a chat transcript between a business development representative (BDR) and a potential customer. The methods include extracting, from the multiple communications, one or more features for each communication in the multiple communications based on a pre-generated taxonomy, generating a training dataset that includes multiple training samples, each training sample mapping at least one extracted feature of a particular communication to a metric indicative of progress of a sales process, and training a machine learning model using the training dataset to generate a trained model that accepts as input, features extracted from a run-time communication associated with the sales process, and outputs a suggested follow-up communication likely to improve progress of the sales process.

Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. In some implementations, extracting the one or more features includes detecting one or more keywords conforming to the taxonomy.

In some implementations, generating the training dataset further includes computing, based on each communication, a score or a label indicating a quality of the communication.

In some implementations, training the machine learning model further includes classifying a particular communication as beneficial or detrimental to the progress of the sales process.

In some implementations, the methods further include receiving, the run-time communication associated with the sales process, extracting, from the run-time communication, at least one feature conforming to the taxonomy, providing the extracted at least one feature to the trained model, and obtaining, from the trained model, the suggested follow-up communication likely to improve the progress of the sales process.

In some implementations, the suggested follow-up communication is displayed on a user-interface presented to a BDR participating in a sales pitch with a potential customer.

In some implementations, training the machine learning model further includes contextualizing the training samples based on data from one or more sources.

Particular embodiments of the subject matter described in this specification can be implemented so as to realize one or more of the following advantages. By training a machine-learning (ML) model based on features extracted from communications between BDRs and corresponding leads in past sales, the ML model can be configured to provide effective suggestions, e.g., a “next best action” (NBA), that can be potentially useful in yielding improved efficiency in and/or probabilities of closing a sales deal. For example, the effective suggestions can result in a shortened timeline for closing the sales deal or an improve likelihood that the BDR will close the sales deal, e.g., as compared to a scenario where it is not used. Closing the sales deal with improved efficiency and increased probability may reduce use of resources (e.g., time spent by BDR for the sales deal) and/or improved return of effort (e.g., higher margins for the BDR). Specifically, features extracted from past communications are mapped to metrics indicative of progress of a sales process (e.g., a metric indicating whether a particular feature led to a desirable or undesirable outcome at a particular stage of the sales process) such that the trained model can suggest, based on communications during an ongoing sales process, what follow-up actions or communications of the BDR is likely to increase the chances of an eventual successful sale. As such, the technology described herein allows for extraction of nuanced features from communications and automatic data-driven recommendations that can potentially increase the likelihood of a sales process being successful.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system over which a BDR communicates with a potential customer.

FIG. 2 is a block diagram of an example intelligent assistant deployed in an enterprise server in accordance with embodiments of the present technology.

FIG. 3 is an example of entities and their relationships of an example graph database.

FIG. 4 is a flow diagram of an example process of providing, based on a trained ML models recommendations to a BDR.

FIG. 5 is a flow diagram of an example process of training a recommendation model by the intelligent assistant.

FIG. 6 is a block diagram of an example computer system that can be used to perform operations described.

FIGS. 7A and 7B are block diagrams of example sales processes.

FIG. 8 is a block diagram of another example system over which a BDR communicates with a potential customer.

FIG. 9 block diagram of another example system over which a BDR communicates with a potential customer.

FIG. 10 is a block diagram of another example system over which a BDR communicates with a potential customer.

### DETAILED DESCRIPTION

A sale process (e.g., a sales cycle) often involves multiple steps, for example, identifying potential customers, communicating with the potential customers, and converting the potential customers to actual customers (also referred to as conversion). This document describes technology that generates, using a trained machine-learning (ML) model that leverages patterns of past successes and failures from prior sale processes, real-time recommendations configured to assist a BDR to move a sale process towards a successful completion.

A sale process can involve a step of identifying one or more sales leads responsible for procuring products and/or services from a business. These leads are then each assigned to a business development representative (BDR) of the business who pursues the opportunity by communicating with the potential customer. If the potential customer ultimately decides to purchase the product and/or service, the sale process can be considered as complete and successful. Typically, such a sale process includes multiple steps, e.g., multiple rounds of communications with the potential customer and several actions/follow-ups by the BDR. Analyses of the multiple steps, e.g., communications between the parties, of sale process can yield insights whether the process is moving towards a successful culmination or not. A repository of sales processes can be used to generate training data for a ML model, where the training data can be generated from extracted insights from the sales processes. The technology described here includes training a ML model using such multiple rounds of communications from prior sales processes—together with the information of whether or not such communications were helpful in moving the corresponding processes towards a successful resolution—such that the trained model can be used to generate recommendations for actions that are likely to culminate in a successful sale. Specifically, the training data set used herein includes a set of vectors generated from BDR-customer sales processes, each vector mapping at least one extracted feature of a particular sales process to a metric indicative of progress of a sales process. During run-time, features extracted from a real-time communication (email, chat transcript, voice call transcription, etc.) are input to the trained model that is configured to output a suggested follow-up communication/action that is likely to move the sales process towards a successful resolution.

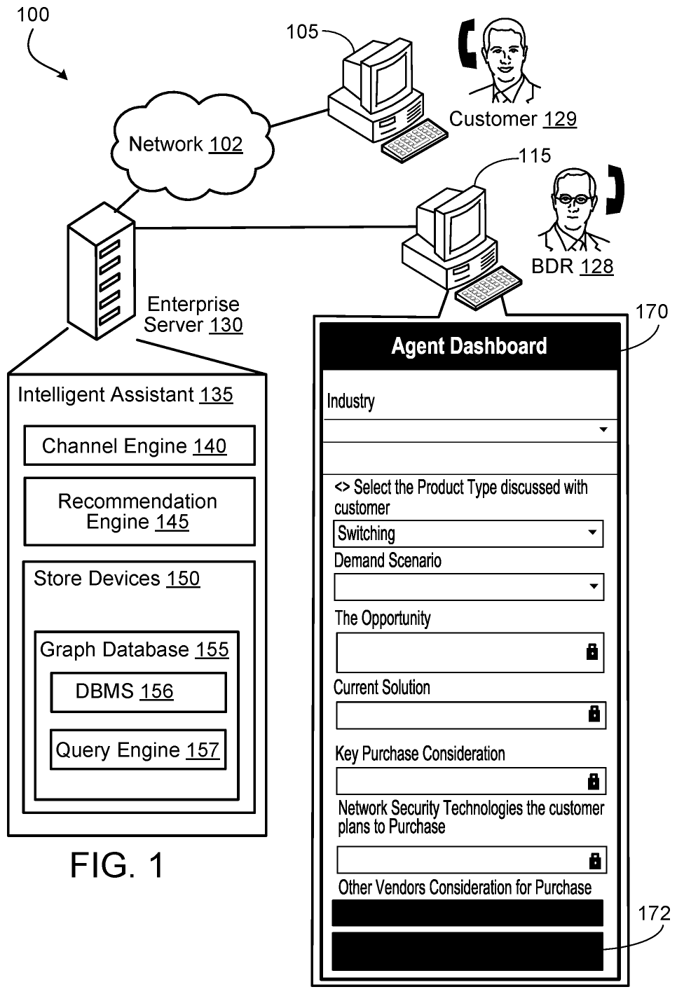

FIG. 1 is a block diagram of an example system 100 where a BDR 128 communicates with a potential customer 129. FIG. 1 includes a one or more client devices 105 that communicate with one or more enterprise servers 130 over a network 102. The system also includes one or more enterprise terminal devices 115 communicatively coupled to the one or more enterprise servers 130. In some implementations, the client devices 105 and terminal devices 115 are speech enabled devices that are configured to accept and recognize speech from a user and often express to a user voice prompts and speech responses. For example, a terminal device 115 and a client device 105 can include a speech detection and transcription module that converts speech of the BDR 128 and the customer 129, respectively, into text and transmits the text to the enterprise server 130. In some implementations, the terminal device 115 and the client device 105 are configured to capture and transmit speech to the enterprise server 130, where the speech is detected and transcribed. In some implementation, the speech-enabled devices of FIG. 1 are also capable of communications over various channels such as text, chat, email, telephony, chatbots, etc.

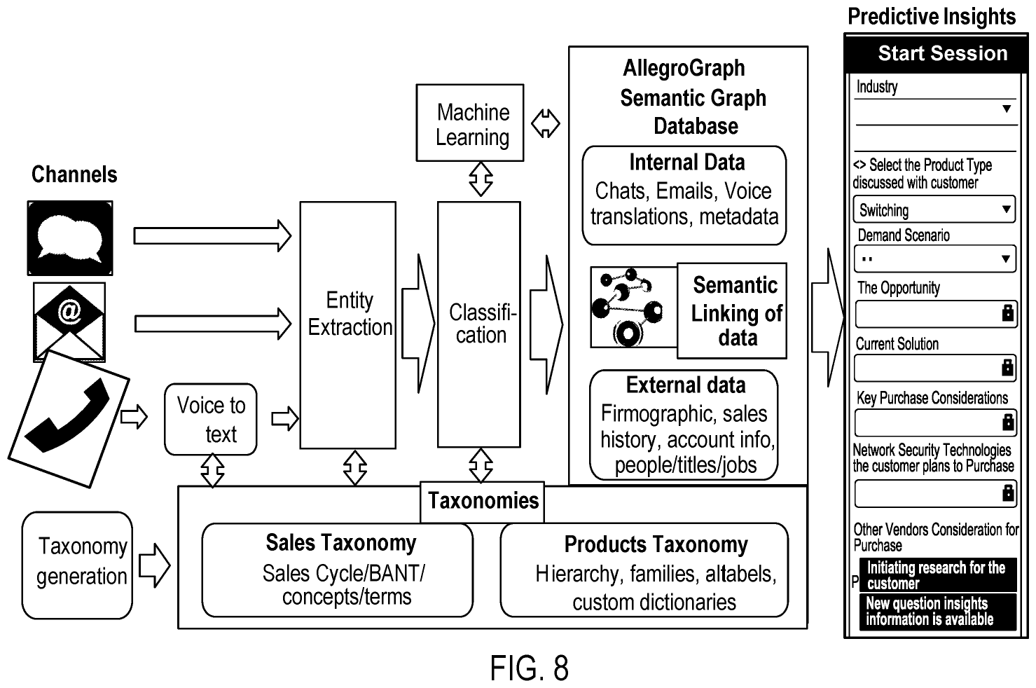

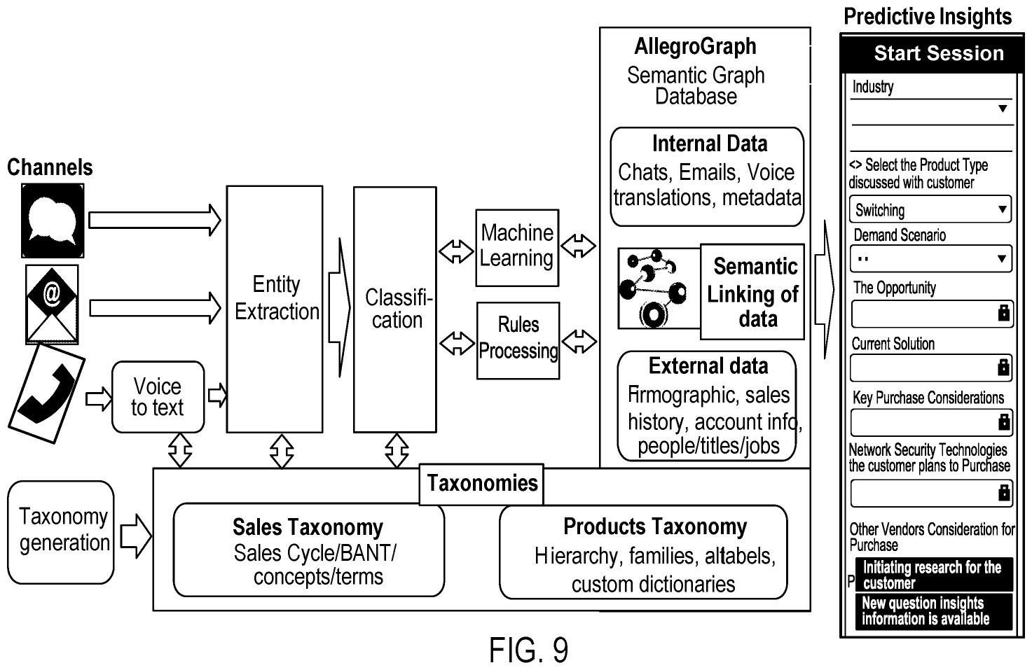

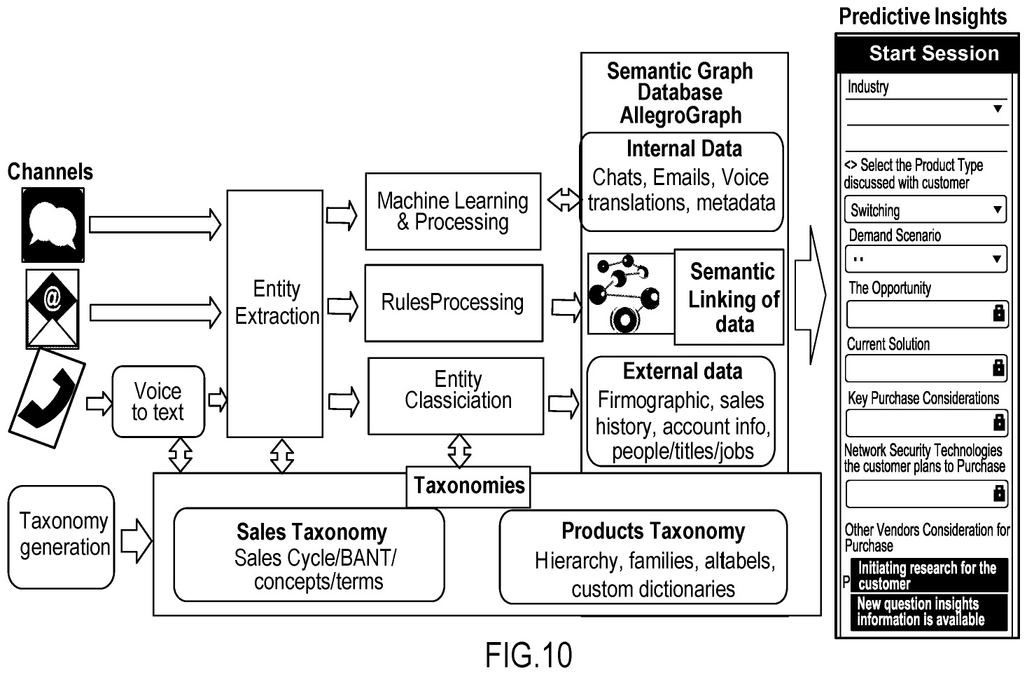

In FIG. 1 a BDR 128 can use a terminal device 115 to communicate with the client device 105. The terminal device 115 is connected to an enterprise server 130 that includes an intelligent assistant 135. The enterprise server 130 can be implemented as one or more computing devices that store programs serving the collective needs of an enterprise. An enterprise server can include hardware as well as software, operating system, firmware, etc. The enterprise server 130 can be configured to perform some or all of the various processes described herein and can perform the operations described herein related to the system, for example, as depicted in FIGS. 8, 9, and 10.

The intelligent assistant 135 of FIG. 1 is a platform capable managing communications between a BDR 128 and a potential customer 129. In some implementations, the intelligent assistant 135 includes a channel engine 140 that is configured to manage disparate communications channels and provide the communications usable by the intelligent assistant 135 to develop insights according to technology described herein. Examples of disparate communications channels can include chat, email, voice calls, text messages, call notes etc.

In some implementations, the channel engine 140 is configured to transcribe audio data by converting audio data of conversations to textual data representing the conversations. For example, if the BDR 128 and a potential client 129 communicates using a phone call, the channel engine 140 can analyze the audio data of the conversations and converts the audio data into textual data for future correspondence. For example, the channel engine 140 can include a natural language processing (NLP) and automatic speech recognition (ASR) engine for processing audio data of a conversation and converting it to speech-to-text.

The intelligent assistant 135 can also include one or more data storage devices 150 to store various communications between BDRs and potential/actual customers. In some implementations, the various communications may be identified based on one or more attributes of the communications, as provided, for example, by metadata associated with the communications, the content of the communications itself or other identifying information associated with the communications. Examples of such attributes can include (i) an identification of a BDR, (ii) an identification of a potential/actual customer, (iii) the sales campaign, (iv) a time of communication between a BDR and a potential/actual customer, (v) content of communication including for example, product identification, stage of negotiation, keywords etc.

In some implementations, communication data is stored in the storage device 150 as a semantic graph database 155 (also referred to simply as a graph database) that is capable of integrating heterogeneous data from various sources. In some implementations, the graph database 155 can organize the communication data in a knowledge graph that can focus on the relationships between entities and is able to infer new knowledge out of existing information. This automatic linking is powerful when fusing data from inside and outside company databases, such as corporate email, documents, spreadsheets, customer support logs, relational databases, government/public/industry repositories, news feeds, customer data, social networks and much more. The graph database 155 includes a database management system (DBMS) and a query engine 157. The query engine 157 receives structured queries and retrieves stored information in response. At times, the query engine 157 can receive unstructured queries and convert the unstructured queries into structured queries (e.g., using SPARQL or similar techniques) to retrieve stored information. Although described herein with reference to storing communication data in a knowledge graph of a graph database, other database structures can be used. For example, a relational database, e.g., a SQL database, can be used to store and query for the communication data.

In some implementations, the intelligent assistant 135 can make use of a pre-generated taxonomy to process communication between the BDR and customer, and store the extracted information in graph database 155, e.g., in a semantic knowledge graph. The taxonomy can include, for example, words or set of words (e.g., phrases) with a defined semantic that can vary based on the business and the products offered by the business. The taxonomy can include, for example, keywords (e.g., phrases) related to the business, products, services, common questions or statements that are frequently used by the BDR 128 and the potential customer 129 while communicating. In some implementations, the intelligent assistant 135 can refer to the pre-generated taxonomy to identify entities and relationships in the communication data between the BDR 128 and the potential customer 129 prior to storing the entities and their relationships in the graph database 155, e.g., in a semantic knowledge graph.

In some implementations, the intelligent assistant 135 can also use pre-generated taxonomies related to the product and/or service offered by the business. For example, a pre-generated taxonomy pertaining to a business identifies the portfolio of products that exist in a given business area. The taxonomy can further represent the hierarchy and relationships between the different products and capabilities that exist within the business. For example, a product taxonomy is the logical and structural organization of products and their hierarchical arrangement. In some implementations, the intelligent assistant 135 can also store data related to a potential customer 129, prior communications with the potential customer 129, employee of the potential customer 129 who was contacted, designation/job title of the employee of the potential customer 129, a list of queries originating from the potential customer 129 etc.

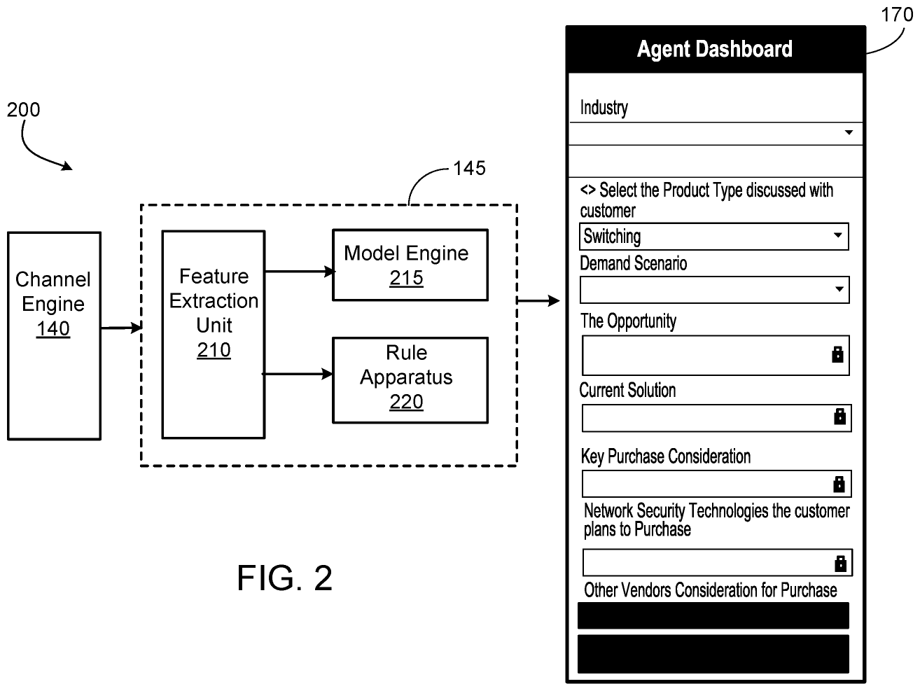

The intelligent assistant 135 can also include a recommendation engine 145 that is configured to implement one or more machine learning models to generate predictions, including recommendations (e.g., a next best action) directed to improving progress of the sales process. The details of the techniques and methods implemented by the recommendation engine 145 is described in more detail with reference to FIG. 2.

In some implementations, the recommendations generated by the intelligent assistant 135 are displayed on a user-interface (also referred to as an agent dashboard) 170 the terminal device 115 of a BDR 128. The agent dashboard can include, for example, various controls (drop down menus, Tillable boxes, etc.) for accepting input from a BDR during a live communication with a potential customer 129. In some implementations, a BDR can link a previous communication (e.g., email, chat transcript, phone transcripts etc.) with the potential customer through the agent dashboard 170. The inputs received through the agent dashboard can be provided to the intelligent assistant 135, which in turn leverages a trained machine learning model to generate recommendations, potentially in real-time or near-real-time, for the BDR to follow during the communication with the potential customer. In some implementations, the agent dashboard can present an alert (e.g., a pop-up display 172) to notify a BDR that a recommendation regarding a follow up communication/action is available for use. Activating the pop-up display (for example, by clicking on the pop-up display) can cause the corresponding recommendation to be displayed on the agent dashboard.

FIG. 2 is a block diagram of an example intelligent assistant 135 deployed in an enterprise server. The example intelligent assistant 135 of FIG. 2 includes the channel engine 140, the recommendation engine 145 and the storage device 150. In some implementations, the recommendation engine 145 can include a feature extraction unit 210 that is configured to process textual data from the channel engine 140 indicating conversations between a BDR 128 and a potential customer 129 to generate one or more features such as a context of the communication, a product and/or service, an industry category of the potential customer, budget of a potential customer. In some implementations, the feature extraction unit 210 can also perform one or more sentiment analysis processes to generate features indicating the sentiments of the potential customer. The sentiment analysis processes can use natural language processing (NLP) techniques such as topic modeling, text classification, keyword extraction, lemmatization and stemming.

In some implementations, the feature extraction unit 210 can use the pre-generated taxonomies stored by the intelligent assistant 135 to process communications between BDRs and customers, where each communication is at least a portion of a sales cycle. The communications between BDRs and customers can be collected from various sources and can be representative of different outcomes of respective sale cycles.

The feature extraction unit 210 can identify words and phrases that are deemed as important for identifying the context of the communication. The identified words and phrases can be used as features generated by the feature extraction unit 210. For example, a pre-generated taxonomy can include words or set of words (e.g., phrases) with a defined semantic that can vary based on the business and the products offered by the business. The feature extraction unit 210 can refer the pre-generated taxonomies to identify words or phrases in the communication between the BDR 128 and the potential customer 129 that are also included in the pre-generated taxonomies. The taxonomies can be used to process the converted text from the communications between the BDR and customers and store the extracted data in a semantic knowledge graph within the graph databased 155, e.g., as semantic triples.

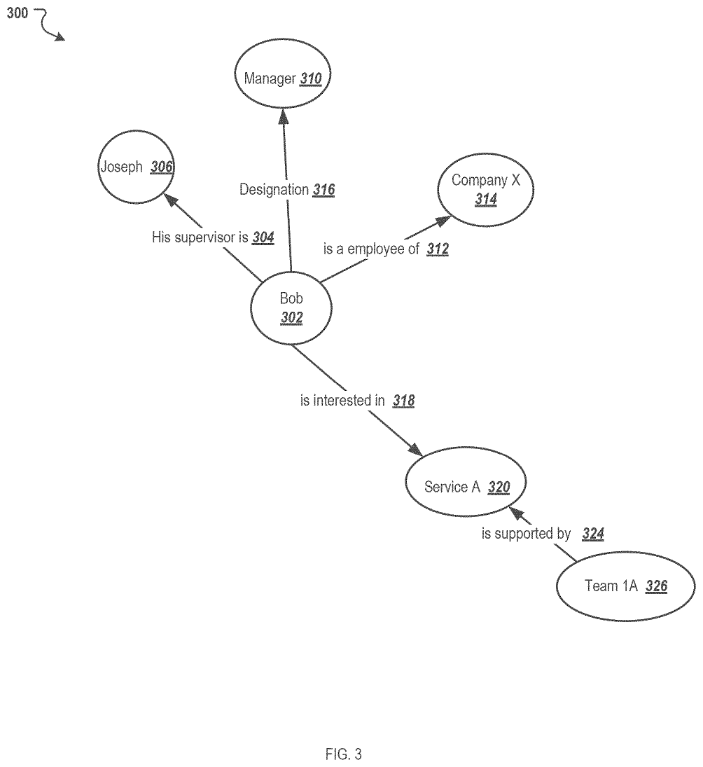

In some implementations, the feature extraction unit 210 can use the graph database 155 to store/identify features and their relationships. This is further explained with reference to FIG. 3.

FIG. 3 is an example of a graph 300 of entities and their relationships. The example graph 300 of FIG. 3 represents Bob who is a manager of a company X and interested in a Service A. In the example of FIG. 3, the nodes themselves represent various entities or subjects as extracted from textual data in accordance with a particular taxonomy and/or ontology. Examples of nodes/entities/subjects include <Bob> 302, <Joseph> 306, <Manager> 310, <Company X> 314, <Service A> 320, and <Team 1A> 326. The graph edges represent relations among the node, that is, represent the predicates <his supervisor is> 304, <has a designation of> 316, <is an employee of> 312, <is interested in> 318, <is supported by> 324 respectively.

In some implementations, the feature extraction unit 210 can identify subjects and their corresponding relationships by analyzing communication data in real time to generate one or more features that indicate contextual information of communications and information regarding the potential client 129. For example, the if the BDR 128 is communicating with <Bob 302>, the feature extraction unit 210 can generate as a feature the designation of <Bob 302> in the <company X> indicating the importance of the communication. For example, a communication has a higher importance and/or value if <Bob 302> is <Manager 310> when compared to a communication if <Bob 302> is not someone who is likely to have decision-making authority.

In some implementations, the feature extraction unit can be configured to generate training data for training a machine learning model(s) by model engine 215. Channel engine 140 can collect sale processes between multiple BDR and multiple customers, the sales processes including multiple steps of the sale process and an outcome. For example, the intelligent assistant 135 can be configured to store a large dataset of historical communications between various BDRs and corresponding potential customers from prior sale processes. For example, each communication between a BDR and potential client can be provided as input to the feature extraction unit 210 to generate one or more features indicating the context of the communication, a product and/or service, an industry category of the potential customer, budget of a potential customer, the potential customer representative, the designation of the potential customer representative etc. the generated one or more features can be used as independent features for the training dataset.

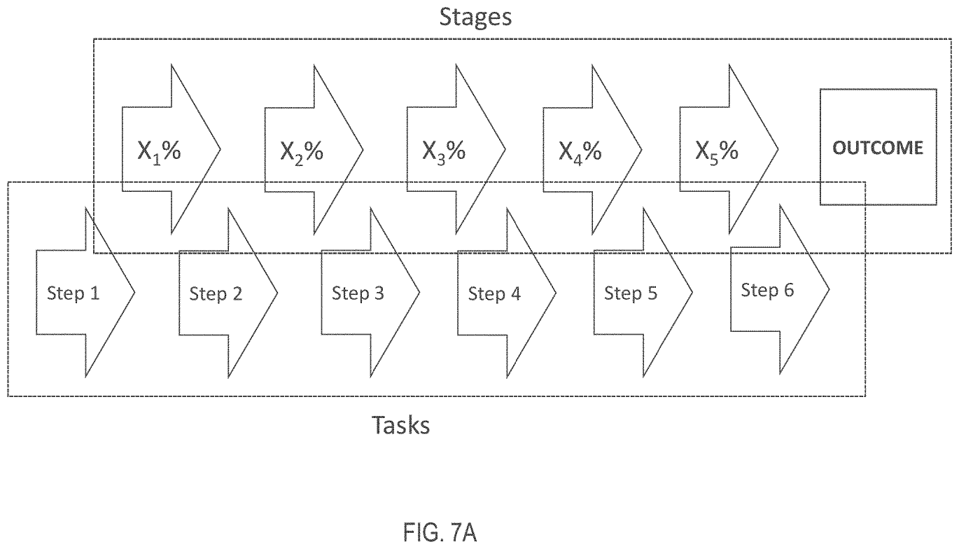

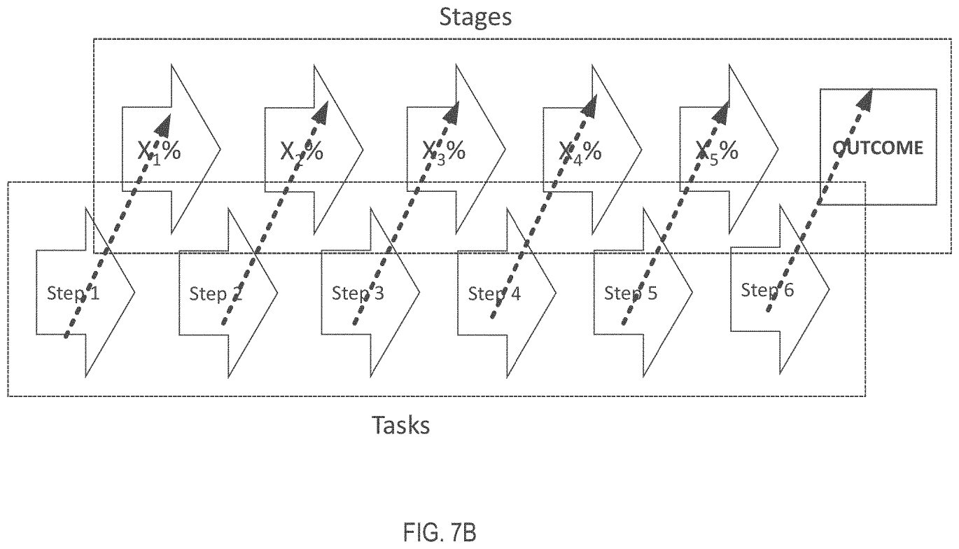

Each sales process includes multiple steps with corresponding stages, e.g., as depicted in FIG. 7A. The multiple steps, e.g., steps 1-6, each represent a step (e.g., sub-process) enacted by the BDR during the sales process to close the business outcome. After each step, a resulting stage of the business outcome is quantified, e.g., as a percentages X1-X5, where each percentage corresponds to a likelihood of the sales process resulting in a closed business outcome. The steps of the sales process can include, for example, one or more rounds of phone conversations between the BDR and the customer, provided literature or other collateral material, quotations of proposed sale, and the like. Each step can include one or more types of data associated with the step, for example, audio data of a call recording, text or graphical collateral material, etc.

In some implementations, the training dataset can be organized as a sequence of communications of each sale cycle. For example, assuming that each sale cycle involves 10 communications between the BDR 128 and the potential customer 129, the training dataset can be organized as a sequence of features generated for each of the communications. In some implementations, the sequence of the training dataset can be further organized based on the timestamps associated to each of the communications so as to organize the communications based on the progress of each sale cycle.

At times, the outcome of the sales process is a closed (successful) business outcome (e.g., a sale of product, a registration for a webinar, a contract for collaboration, etc.). At times, the outcome of a sales process is an open (failed) business outcome (e.g., loss of sale, dropping of communication, customer decided to go elsewhere or declined further contact). A subset of collected sale processes can be provided from the channel engine 140 to the feature extraction unit 210 to generate the training data. The subset of collected sales processes can include (i) successful business outcomes, (ii) failed business outcomes, or (iii) a combination thereof.

In some implementations, the intelligent assistant 135 can assign a score to each training sample of the training dataset indicating a progress of a sales process. A score can quantify a probability (e.g., likelihood) that each step of the sales process results ultimately in a requested outcome (e.g., conversion to a sale) at the end of the sale process. Each step of the process can increase the probability of the requested outcome, where actions taken at a particular step can adjust the probability of the requested outcome by a respective amount. For example, after an initial call, a step including sending a follow up communication can result in a first probability of the requested outcome (e.g., closing a deal/making a sale) and providing relevant literature related to a product of interest can result in a second probability of the requested outcome.

To assign the score, the intelligent assistant 135 can analyze the one or more features of a sequence of communications of a sale process between a BDR 128 and a potential customer 129 to identify the importance of each communication. To assign the score, the intelligent assistant can use the pre-generated taxonomies or a set of rules that are pre-defined. For example, if a sale cycle involves a sequence of communications between the BDR 128 and the potential customer 129, the intelligent assistant 135 can generate and assign a score to each communication based on a set of features that is common across all communications (or a sequence of communications) that lead to a successful sale process. Similarly, the intelligent assistant 135 can also take into consideration, a set of features that is common across all communications (or a sequence of communications) that lead to an unsuccessful sale process. In this example, a successful sale process relates to a sale process that resulted in a potential customer conversion and an unsuccessful sale cycle relates to a sale process that did not result in a potential customer conversion.

In some implementations, the score can be assigned by human evaluators (for e.g., subject matter experts of the relevant field) after analyzing the sequence of communications. For example, human evaluators can analyze each sale process i.e., the sequence of communications between the BDR 128 and the potential customer 129 to assign a score to each communication based on the relative importance of each communication towards a successful or an unsuccessful potential customer conversion.

In some implementations, metadata to enrich the extracted data for a sales process can be provided as user-input, e.g., by a manager of the BDR via a corresponding user-interface. For example, the user-input can include metrics of progress for one or more stages corresponding to step taken in the sales process, e.g., assigned percentages for the characteristics of the sales process at a step in the sales process. The assigned percentages can additionally be assigned a currency value for a sales opportunity defined by the sales process, which results in a net revenue (or net loss) for the BDR. At times, the percentages can be incremental, e.g., increasing in magnitude, between 0 to 100% for sequential steps of the sales process. In some implementations, the user-interface can be configured to allow for distinguishing, at each step, how different measures taken during the step resulted in different metrics of progress (e.g., likelihood of closed business outcome) at the corresponding stage of the sales process. For example, the user-interface can allow for specifying that a phone call at a second step could result in a larger increase in probability of closing the sale process than an email communication at the second step.

In some implementations, training data can be stored as multiple n-dimensional sales progress vectors, where each vector corresponds to a step in the sales process between a BDR and customer. For example, as depicted in FIG. 7B, a corresponding vector can be generated for each step 1-6, corresponding stages X1-X5, and including ultimate outcome of the sales process. In some implementations, a vector can correspond to two or more of the steps (e.g., all the steps) of a sales process between a BDR and customer.

In some implementations, training data can be stored as multiple n-dimensional sales progress vectors, where each vector corresponds to two or more steps (e.g., a full cycle) of a sales process between a BDR and customer.

The n-dimensional vector is configured to store, within the n-th dimensions, structured data extracted from the step of the sales process. The structured data can correspond to actions taken at each step of the sales process including, for example, one or more features for a communication analyzed based on a pre-generated taxonomy. Structure data can include, for example, structured strings, numerical values, etc. The structured data can conform to a taxonomy, e.g., taxonomy used to by the intelligent assistant 135 to process the communication data and store the communication data in the graph database 155.

In some implementations, a vector can include structured data corresponding to various features related to a taxonomy specific to the sales process, including, for example:

Next steps—Information indicative of whether a follow-up meeting was set up, and/or the next steps were otherwise confirmed between the BDR and the potential customer. This can include, for example, timeline information indicative of an expected time (e.g., a specific date) after which one party is to contact the other or take another action indicative of a progress of the process.

Industry—Information indicative of the industry pertaining to the sales call.

Budget, Authority, Need, Timing (BANT)— Information indicative of one or more of a budget associated with the sales, designation and decision-making authority of potential customer 129, need/requirement associated with the sale process, and timing/timeline/timeframe associated with the goods/services being presented in the sales pitch by the BDR 128.

Cost—Information indicating whether the cost was specifically discussed/identified.

Specific product—Information indicative of whether specific products/brands were identified in the communications

Level of engagement of potential customer—Information indicative of how much each of the BDR and the potential customer participated in the conversation. In some cases, a high level of participation by the potential customer can indicate a heightened interest in the product/services being pitched. On the other hand, a low level of participation by the potential customer can indicate a potential low level of interest.

Sentiment—Information indicative of a sentiment (e.g., excitement) of the potential customer. For example, a statement such as “We are very much looking forward to the meeting, we've been interested in you guys or a while” can indicate a high level of interest in the products/services being pitched. On the other hand, indifference or anger can indicate a low interest and therefore potentially low chances of an eventual success.

BDR performance—Information indicative of the quality of the BDR's performance. This can include, for example, information indicative of whether the BDR asked about timeline, costs, specific products etc., information indicative of whether the BDR mentioned/patched in another person as needed to increase the chances of a successful sale, information indicative of whether the BDR asked open ended questions, information indicative of the historical performance of the BDR in comparison to others, etc.

Progress statistics—Information indicative of the progress of the sale (e.g., a metric such as a percentage or other numerical value indicative of how far away the process is from the beginning and/or a successful culmination).

In some implementations, the feature extraction unit can be configured to generate vectors including structured data corresponding the one or more features for each step of the sales process of a set of multiple sales processes analyzed based on a pre-generated taxonomy. The multiple sales processes can represent a subset of a collection of sales processes having different business outcomes. The multiple sales processes can be processed to generate respective vectors which can then be used as training data for the ML model.

The recommendation engine 145 can include a model engine 215 that implements one or more machine learning models to generate a suggested action (e.g., a follow-up communication) that is likely to improve progress of the sales process. The intelligent assistant 135 is configured to train the one or more machine learning models using the generated training dataset (e.g., the generated sales progress vectors) from the sales processes, e.g., as described above. The trained machine learning model(s) can be trained to identify what steps (e.g., actions at each step) result in successful business outcomes. For example, the ML model can predict, for a stage in the sales process, a next best action based in part on a predicted impact of the next best action on a likelihood (e.g., percentage) that the business outcome is positive (e.g., a closed deal). Training the machine learning model(s) can include performing vector comparisons to identify clusters of steps (e.g., actions), where the identified clusters can then be used to identify commonalities in outcome for those clusters of actions.

In some implementations, the intelligent assistant 135 uses the training dataset to train a machine learning model (also referred to as a scoring model) to generate and assign scores to each training sample of the training dataset indicating a progress of a sales process. To train the scoring model, the intelligent assistant 135 can adjust the parameters of the scoring model so as predict the scores that were previously assigned (e.g., labeled/annotated) by the human evaluators based on a loss function. By employing such a method, the intelligent assistant 135 can minimize the tasks of human evaluators by using the scoring model instead of human evaluators for scoring the training samples for future purposes. Example of machines learning model can include neural network, linear or non-linear regression etc.

In some implementations, after generating the training dataset, the intelligent assistant 135 and/or the model engine 215 can train one or more machine learning models (recommendation model) to learn the under lying patterns in the sequence of communications for a successful and unsuccessful customer conversion. The recommendation models can include training parameters that can be trained on the training dataset to select a follow-up topic for communication (or another action) that when presented to a potential customer 129 is likely to improve the progress of the sale process. For example, the selected follow-up topic can be a next obvious piece of information needed by the potential customer 129 to make a decision regarding opting or buying the product and/or service. As for another example, the selected follow-up topic can be information regarding competitors and their products. As for another example, the selected follow-up topic can be information related to the pricing of the product and/or service.

In some implementations, the recommendation models are configured to provide, as output, a ranked list of pre-defined topics, where each topic of the list includes a corresponding score for impact on the business outcome. For example, instead of generating a topic to improve the progress of the sale process, the recommendation models can rank a likelihood (or a probability) of impact on business outcome to pre-defined topics. In such an implementation, a pre-defined topic that is assigned a higher likelihood compared to other pre-defined topics can be assumed to have a better chance of improving the progress of the sale process.

In some implementations, the intelligent assistant 135 can also include a rule engine 220 that is configured to select (or generate) a follow-up action or topic for communication that when presented to a potential customer 129 is likely to improve the progress of the sale process. At times, the rule engine 220 can be used instead of, or in addition to, the ML recommendation model to determine a next best action. For example, the system may use a rules engine 220 instead of a ML model in instances where a complexity threshold is not met, e.g., where a number of “next best actions” are well understood and/or finite in nature. In another example, the system may use a ML model in instances where a complexity threshold is exceeded, e.g., where a number of “next best actions” are not well understood and/or the details of the sales processes are not well characterized or not deterministic. At times, the rules engine 220 can be used in addition to the ML model, e.g., to validate choices made by the rules engine 220 with predictions generated by the ML model. In some implementations, the rules according to which the rule engine 220 functions can be defined by the subject matter experts. For example, if according to the current communication between a BDR 128 and a potential customer 129, the rule engine 220 can determine that the potential customer 129 is concerned about the pricing of the product and/or service offered to the potential customer 129, the rule engine 220 can check prior successful sale processes to determine a topic (or information) that can be presented to the potential customer 129 so that the customer 129 is satisfied. For example, if the rule engine 220 determines that in one or more of the prior successful sale processes, the potential customer 129 was concerned with pricing of the product and/or service, the rule engine 220 can analyze the subsequent communications to identify topics (e.g., competitor pricing, or deals in the current pricing) that satisfied the potential customer 129. After determining the topics, the rule engine 220 can select a topic from the identified topics as a recommendation to the BDR 128.

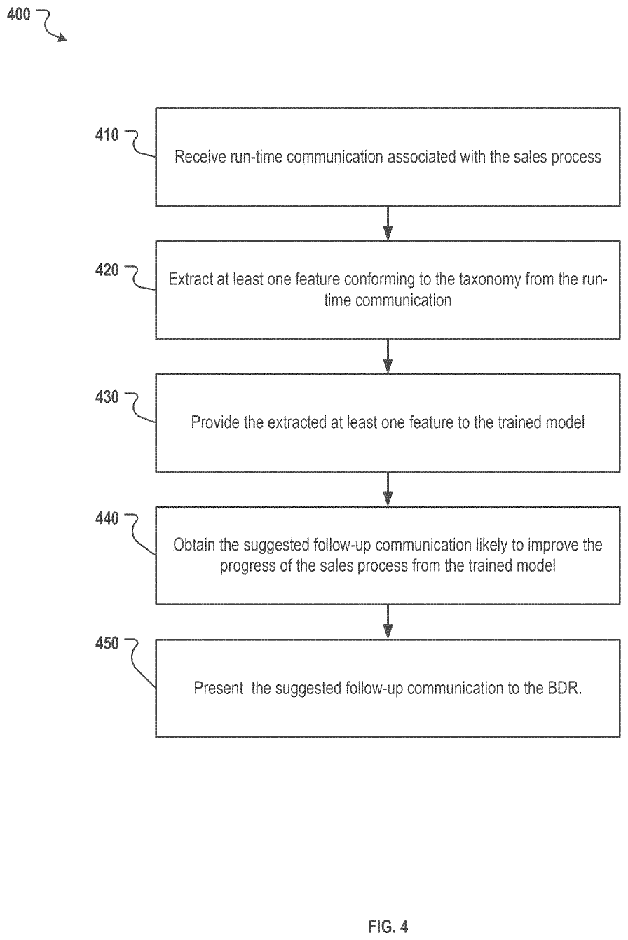

In some implementations, while communicating with a potential customer 129, a BDR 128 has access to the dashboard 170 on the terminal computer 115 that presents the topics recommended by the intelligent assistant 135 that is likely to improve progress of the sales process. This is further explained with reference to FIG. 4.

FIG. 4 is a flow diagram of an example process 400 of using the recommendation model by the BDR 128. Operations of process 400 are described below as being performed by the components of the system described and depicted in FIGS. 1-3. Operations of the process 400 are described below for illustration purposes only. Operations of the process 400 can be performed by any appropriate device or system, e.g., any appropriate data processing apparatus. Operations of the process 400 can also be implemented as instructions stored on a non-transitory computer readable medium. Execution of the instructions cause one or more data processing apparatus to perform operations of the process 400.

Operations of the process 400 can include receiving run-time communication associated with the sales process (410). For example, during a communication session between a BDR 128 and a potential customer 129, the enterprise server 130 receives all communications originating from the potential customer and the BDR in real time. The communication can be over various other channels such as text, chat, email, telephony, chatbots.

Operations of the process 400 also includes extracting at least one feature conforming to the taxonomy from the run-time communication (420). Since the communication can be over disparate channels such as text, chat, email, telephony, chatbots, the intelligent assistant 135 can convert real time communication into textual data. For example, the intelligent assistant 135 can transcribe audio data from telephonic conversations to textual data. The intelligent assistant 135 includes a feature extraction unit 210, which processes the textual data of the real time communications to generate one or more features such as a context of the communication, a product and/or service, an industry category of the potential customer, budget of a potential customer. The feature extraction unit 210 can function substantially similarly to as described above with reference to FIG. 2.

Operations of the process 400 further includes providing the extracted at least one feature to the trained machine learning model (430). After extracting the one or more features from the real time communication between the BDR 128 and the potential customer 129, the extracted features can be provided as input to the trained recommendation model to generate the suggested follow-up action (e.g., a topic/modality of communication) with the potential customer 129 that is likely to improve the progress of the sales process from the trained model (440). In some implementations, the follow-up action can be a “next best action” to improve an outcome of the sales process (e.g., close a deal). The follow-up action can include, for example, a follow-up communication (e.g., phone call, email, letter, etc.), a collateral document (e.g., white paper, product sheet), or the like. At times, the next best action can include best introductory call talking points, best email/chat communiques, best follow-up call talking points, best use case/proof industry and job role, best objection handling, or best closing tactics. Each of the next best actions can include further implementation details, e.g., phrases, words, documentation, or the like, for the BDR to use during the enactment of the next best action.

The suggested follow-up action is presented to the BDR 128 (450). For example, the suggested follow-up topic for communication with the potential customer 129 is presented on the dashboard of the terminal computer 115. The BDR 128 can then either choose to communicate with the potential customer 129 on the recommended topic or any other topic depending upon the situation.

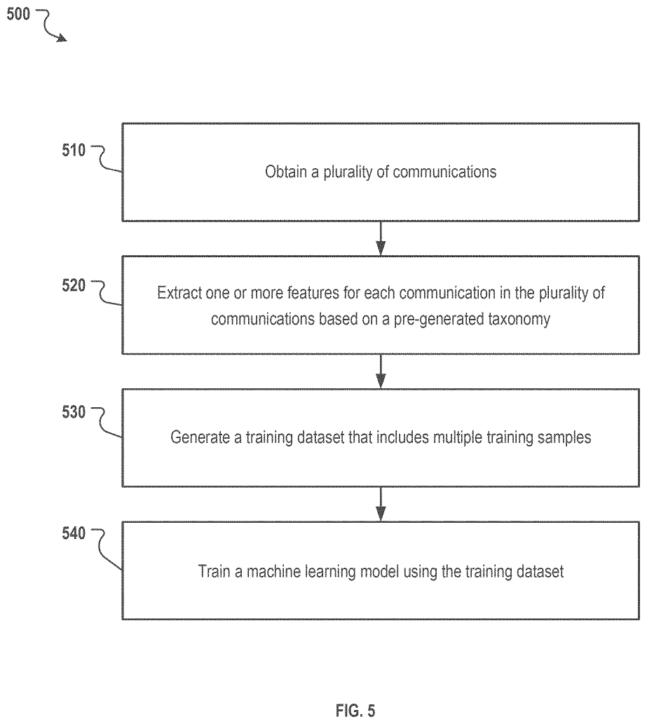

FIG. 5 is a flow diagram of an example process 500 of training a recommendation model by the intelligent assistant 135. Operations of process 500 are described below as being performed by the components of the system described and depicted in FIGS. 1-3. Operations of the process 500 are described below for illustration purposes only. Operations of the process 500 can be performed by any appropriate device or system, e.g., any appropriate data processing apparatus. Operations of the process 500 can also be implemented as instructions stored on a non-transitory computer readable medium. Execution of the instructions cause one or more data processing apparatus to perform operations of the process 500.

Operations of the process 500 includes obtaining a plurality of communications (510). For example, the intelligent assistant 135 can include one or more data storage devices 150 from which the communications are obtained. Over a period of time, the intelligent assistant 135 can receive a plurality of communications pertaining to different sale processes between different BDRs 128 and potential clients 129—which in turn are obtained for the purposes described herein.

Operations of the process 500 includes extracting one or more features for each communication in the plurality of communications based on a pre-generated taxonomy (520). For example, the intelligent assistant 135 includes a feature extraction unit 210 that processes the textual data of the real time communications to generate one or more features, for example as described above with respect to FIG. 2. In some implementations, extracting the one or more features includes detecting one or more keywords conforming to the taxonomy.

Operations of the process 500 includes generating training dataset that includes multiple training samples (530). For example, the intelligent assistant 135 can use the one or more features generated by the feature extraction unit 210 to generate n-dimensional vectors corresponding to each step of a sales process for multiple sales processes. For example, each communication between a BDR and potential client can be provided as input to the feature extraction unit 210 to generate one or more features indicating the context of the communication, a product and/or service, an industry category of the potential customer, budget of a potential customer, the potential customer representative, the designation of the potential customer representative etc. The generated one or more features can be encoded (e.g., populated) into vectors as structured data. Each step of the sales process can be further segmented, where each segment of the step can be individually assigned a score corresponding to predicted impact on the business outcome of the sales process. Each of the segments can be classified/categorized, such that metadata assigned to the classified/categorized segments can be embedded into the vector generated from the data. At times, the classification/categorization of the segments of each step can be performed by a human operator. In some implementations, classification/categorization can be applied using a knowledge graph of the graph database, where the knowledge graph includes associations for terms/phrases with classes/categories related to the sales process.

In some implementations, a vectors can be assigned a label (or score) indicative of whether (and/or how much) the step (e.g., the actions taken during the step) was beneficial or detrimental to the progress of the sales process. In other words, how the step affected an outcome of the sales process, e.g., increased or decreased a likelihood of the business outcome.

In some implementations, the intelligent assistant 135 can assign a score to each step of the sales process. For example, the intelligent assistant 135 can analyze the one or more features of a sequence of communications of a sale process between a BDR 128 and a potential customer 129 to identify the importance of each communication. To assign the score, the intelligent assistant can use the pre-generated taxonomies or a set of rules that are pre-defined. In some implementations, the score can be assigned by human evaluators (for e.g., subject matter experts of the relevant field) after analyzing the sequence of communications.

Operations of the process 500 can include training a machine learning model using the training dataset (540). For example, the intelligent assistant 135 uses the training dataset, e.g., the generated vectors, to train one or more machine learning models to learn the underlying patterns in the sequence of communications for a successful and unsuccessful customer conversion. The recommendation models can include training parameters that can be trained on the training dataset to select a follow-up action and/or topic/modality of communication that when presented to a potential customer 129 is likely to improve the progress of the sale process. For example, the selected follow-up topic/action can be a next piece of information needed by the potential customer 129 to make a decision regarding opting or buying the product and/or service. As for another example, the selected follow-up topic can be information regarding competitors and their products. As another example, the selected follow-up topic can be information related to the pricing of the product and/or service.

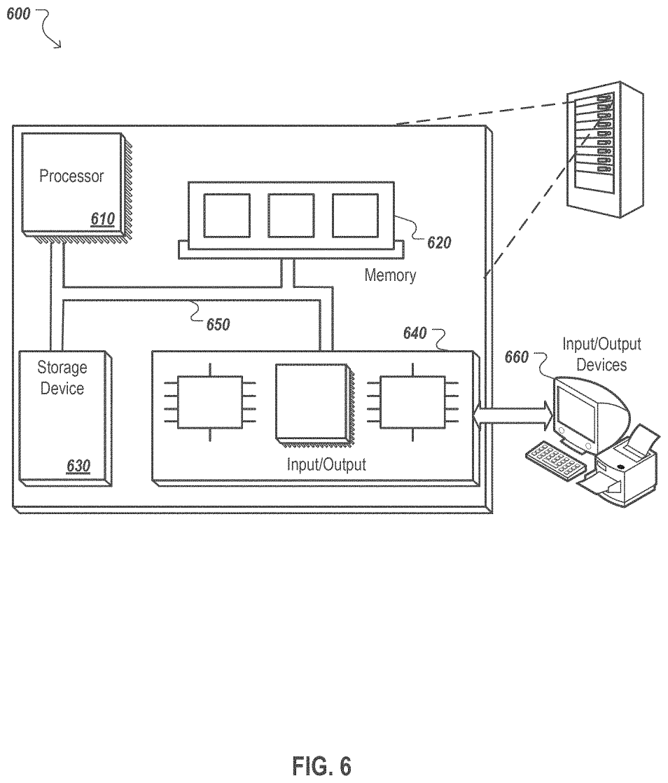

FIG. 6 is a block diagram of an example computer system 600 that can be used to perform operations described above. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to peripheral devices 660, e.g., keyboard, printer and display devices. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML, page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
obtaining a plurality of communications, each communication in the plurality of communications representing one of: a phone conversation transcript, an email, or a chat transcript between a business development representative (BDR) and a potential customer;
extracting, from the plurality of communications, one or more features for each communication in the plurality of communications based on a pre-generated taxonomy;
generating a training dataset that includes multiple training samples, each training sample mapping at least one extracted feature of a particular communication to a metric indicative of progress of a sales process; and
training a machine learning model using the training dataset to generate a trained model that accepts as input, features extracted from a run-time communication associated with the sales process, and outputs a suggested follow-up communication likely to improve progress of the sales process.

2. The computer-implemented method of claim 1 wherein extracting the one or more features includes detecting one or more keywords conforming to the taxonomy.

3. The computer-implemented method of claim 1 wherein generating the training dataset further comprises computing, based on each communication, a score or a label indicating a quality of the communication.

4. The computer-implemented of claim 1 wherein training the machine learning model further comprises classifying a particular communication as beneficial or detrimental to the progress of the sales process.

5. The computer-implemented method of claim 1, further comprising:
receiving, the run-time communication associated with the sales process;
extracting, from the run-time communication, at least one feature conforming to the taxonomy;
providing the extracted at least one feature to the trained model; and
obtaining, from the trained model, the suggested follow-up communication likely to improve the progress of the sales process.

6. The computer-implemented method of claim 1, wherein the suggested follow-up communication is displayed on a user-interface presented to a BDR participating in a sales pitch with a potential customer.

7. The computer-implemented method of claim 1, wherein training the machine learning model further comprises contextualizing the training samples based on data from one or more sources.

8. The method of claim 7, wherein the one or more sources comprise a semantic graph database storing information internal to an organization associated with the BDR.

9. The method of claim 8, wherein the semantic graph database stores information obtained from servers external with respect to the organization associated with the BDR.

10. The method of claim 1, wherein mapping the at least one extracted feature comprises generating a vector indicative of the progress of the sales process.

11. The method of claim 10, wherein generating the vector comprises encoding the at least one extracted feature as structured data in the vector.

12. The computer-implemented method of claim 1, wherein extracting the one or more features based on the pre-generated taxonomy comprises extracting at least one of the following information: an industry associated with the sales process, a product, a budget of the potential customer, a job title of the potential customer, a need of the potential customer, and a timeframe.

13. The computer-implemented method of claim 1, wherein extracting the one or more features based on a pre-generated taxonomy comprises identifying a decision maker associated with the potential customer.

14. A system, comprising:
one or more computers and one or more storage devices on which are stored instructions that are operable, when executed by the one or more computers, to cause the one or more computers to perform operations comprising:
obtaining a plurality of communications, each communication in the plurality of communications representing one of: a phone conversation transcript, an email, or a chat transcript between a business development representative (BDR) and a potential customer;
extracting, from the plurality of communications, one or more features for each communication in the plurality of communications based on a pre-generated taxonomy;
generating a training dataset that includes multiple training samples, each training sample mapping at least one extracted feature of a particular communication to a metric indicative of progress of a sales process; and
training a machine learning model using the training dataset to generate a trained model that accepts as input, features extracted from a run-time communication associated with the sales process, and outputs a suggested follow-up communication likely to improve progress of the sales process.

15. A non-transitory computer readable medium storing instructions that, when executed by one or more data processing apparatus, cause the one or more data processing apparatus to perform operations comprising:
obtaining a plurality of communications, each communication in the plurality of communications representing one of: a phone conversation transcript, an email, or a chat transcript between a business development representative (BDR) and a potential customer;
extracting, from the plurality of communications, one or more features for each communication in the plurality of communications based on a pre-generated taxonomy;
generating a training dataset that includes multiple training samples, each training sample mapping at least one extracted feature of a particular communication to a metric indicative of progress of a sales process; and
training a machine learning model using the training dataset to generate a trained model that accepts as input, features extracted from a run-time communication associated with the sales process, and outputs a suggested follow-up communication likely to improve progress of the sales process.
